(19) United States
(12) Patent Application Publication
(10) Pub. No.: US 2012/0178922 A1
(43) Pub. Date: Jul. 12, 2012

(54) Solid Carrageenan Ion Exchange

(75) Inventors: Jan Larsen, Valby (DK); Brian Rudolph, Koege (DK); Iben Hemmingsen, Vanloese (DK); Lennart Nielsen, Stenloese (DK)

(73) Assignee: CP KELCO APS, Lille Skensved (DK)

(21) Appl. No.: 12/985,834

(22) Filed: Jan. 6, 2011

(51) Int. Cl. C08B 37/00

(52) U.S. Cl. 536/123

(57) ABSTRACT

Embodiments of the present invention function to modify the cation concentration of carrageenans using an ion-exchange process. Processes for modifying the cation concentrations of solid carrageenans are provided. The processes include treating solid carrageenan with an aqueous treatment solution comprising an alcohol and a salt and washing the corresponding treated solid carrageenan with an aqueous solution comprising an alcohol.

### FIELD

The present invention relates to carrageenan compositions and processes for making such. More specifically, the present invention relates to making carrageenan compositions with modified cation concentrations and processes that result in increasing or decreasing the concentration of cations in solid carrageenan extracts.

### BACKGROUND

Production of carrageenan can be traced back to Ireland where plants of the red seaweed algae species of Chondrus crispus were first harvested. After harvesting, the weeds were typically washed, sun-bleached, dried, and boiled with milk to form a pudding.

Today, this seaweed pudding is mostly confined to Ireland's cultural history. Carrageenan, however, has become more important because of its effectiveness as a functional additive in forming gels in an aqueous system. Carrageenan is useful in a wide variety of applications, including beer brewing (in which it has been used for over 150 years as a fining) to processed meat and food products like milk drinks and deserts; pharmaceutical preparations such as orally-administered gel caps; personal care products such as toothpaste and skin care preparations; and household products such as air-freshener gel and cleaning gels.

Contemporary methods of carrageenan extraction and production have advanced considerably in the last fifty years. Perhaps most significantly is that today, rather than being gathered from wild-grown seaweed, carrageenan-containing plants such as Cottonii (Kappaphycus alvarezii) and Spinosum (Euchema denticulatum) are more commonly seeded along nylon ropes and harvested in massive aqua-culture farming operations throughout much of the Indian Ocean and along the Asian Pacific Ocean Coastline. As described in U.S. Pat. No. 3,094,517 to Stanley et al. (the disclosure of which is incorporated herein by reference), the carrageenan is extracted from the washed and cleaned seaweed while also at the same time being subjected to alkali modification by placing the seaweed in solution made slightly alkaline by the addition of a low concentration of an alkali salt (i.e., the pH of the solution is raised to a range of, e.g., 9-10), and then heating this solution to a temperature of around 80° C. for about 20 minutes to about two hours.

The temperature at which carrageenan gels and melts is dependent on a number of factors that include the concentration of gelling cations such as potassium and calcium ions. Generally speaking, the higher the concentration of gelling cations the higher the gelling and melting temperature of the carrageenan. Such cations may come not only from the composition to which the carrageenan is added as a gelling agent, but also from the carrageenan itself

When an alkali modification step is used, (i.e., in a traditional extraction process), such as in U.S. Pat. No. 3,094,517, which makes use of calcium hydroxide as alkali modification agent, the resulting cation concentration levels in iota or kappa carrageenan are:
Potassium: About 5% (iota), About 5% (kappa)
Calcium: About 3% (iota), About 2% (kappa)
Magnesium: About 0.1% (iota), About 0.05% (kappa)
Sodium: About 2% (iota), About 1% (kappa)

By contrast, when other alkalis, such as sodium hydroxide or sodium bicarbonate are used as in U.S. Pat. No. 6,063,915 to Hansen et al. (the disclosure of which is incorporated herein by reference), typical cation levels in iota carrageenan are:
Potassium: About 5%
Calcium: About 0.1%
Magnesium: About 0.1%
Sodium: About 5%

Accordingly, there exists a need in the art for a process for controlling the concentration of gelling cations in carrageenan compositions, and thereby modifying the gelling and melting temperatures carrageenans, without substantially depolymerizing the carrageenan or damaging it in some other way.

### SUMMARY

In one aspect, a process for producing an ion-exchanged carrageenan composition is provided. The process comprises the step of treating a carrageenan solid with an aqueous treatment solution comprising a first alcohol in an amount from about 40 vol % to about 60 vol % of the aqueous treatment solution and a salt, wherein the carrageenan solid remains substantially undissolved during the treating step. The process further comprises the step of washing the treated carrageenan solid using a aqueous washing solution comprising a second alcohol in an amount from about 40 vol % to about 60 vol % of the aqueous washing solution to obtain the ion-exchanged carrageenan composition.

In another aspect, a process for producing an ion-exchanged carrageenan composition is provided. The process comprises the step of treating a carrageenan solid with an aqueous treatment solution comprising a first alcohol in an amount from about 40 vol % to about 60 vol % of the aqueous treatment solution and a salt, wherein the carrageenan solid remains substantially undissolved during the treating step and the treatment solution has a pH in the range of about 8 to about 10. The process further comprises the step of washing the treated carrageenan solid using an aqueous washing solution comprising a second alcohol in an amount from about 40 vol % to about 60 vol % of the aqueous washing solution, wherein the aqueous washing solution has a pH in the range of about 8 to about 10, to obtain the ion-exchanged carrageenan composition.

In still another aspect, a process for producing an ion-exchanged carrageenan composition is provided. The process comprises the step of flowing an aqueous treatment solution, comprising a first alcohol in an amount from about 40 vol % to about 60 vol % of the aqueous treatment solution and a salt, through a layer of a carrageenan solid, wherein the carrageenan solid remains substantially undissolved. The process further comprises flowing an aqueous washing solution, comprising a second alcohol in an amount from about 40 vol % to about 60 vol % of the aqueous washing solution, through the layer of the carrageenan solid to obtain the ion-exchanged carrageenan composition.

Additional aspects will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

These and other features, aspects, and advantages of the present invention will become better understood when the following detailed description is read with reference to the accompanying drawings, wherein:

FIG. 1 is a graphical illustration of the concentration of cations in carrageenan after successive treatment steps in accordance with an embodiment of the present invention.

### DETAILED DESCRIPTION

All parts, percentages and ratios used herein is expressed by weight unless otherwise specified. All documents cited herein are incorporated by reference.

As used herein, the term “alkali” means a base according to the Bronsted-Lowry definition, i.e., an alkali is a molecule or ion that accepts a proton in a proton-transfer reaction.

As used herein, the term “solution” means any combination of two or more substances, including but not limited to a heterogeneous mixture, a suspension, a mixture, a sol, a gel, a dispersion, or an emulsion.

As used herein, the terms “traditional,” “traditionally extracted,” or “traditionally treated” carrageenan mean a carrageenan that is subjected to an alkali modification by being contacted with an alkali solution at an elevated temperature (e.g., greater than room temperature) during processing or treatment.

As used herein, the terms “neutral,” “neutral extracted,” or “neutrally treated” carrageenan means a carrageenan that is not contacted with an alkali solution during processing or treatment.

Carrageenans may be more specifically described as generic repeating galactose and 3,6-anhydrogalactose residues linked β-(1-3) and α-(1-4), respectively and with characteristic 4-linked 3,6-anhydro-α-D-galactose and 3-linked β-D-galactose-4-sulphate groups. Kappa carrageenan differs from iota carrageenan only by the presence of a single sulphate group. The molecules arrange themselves in a right-handed double helix with the strands parallel and threefold, again iota and kappa carrageenan are very similar in this regard, with kappa carrageenan forming a slightly more disordered helix. The helix is stabilized by interchain hydrogen bonds through the unsubstituted positions at O-2 and O-6 with the sulphate groups projecting outward from the helix. The sulfate groups typically coordinate cations.

As mentioned above, there is a strong correlation between the presence of gelling cations and carrageenan gelation. Without being limited by theory, it is believed that gels are formed in carrageenan through gelling (primarily monovalent) cations such as Na⁺, K⁺, Rb⁺, Cs⁺, and NH₄⁺ as well as some divalent cations like Ca²⁺ and Mg²⁺ that facilitate side-by-side interaction of the strands to form a three dimensional gel network. Cations such as K⁺, Ca²⁺, and Mg²⁺ are more powerful as gelling ions whereas Na-carrageenan in pure water will be non-gelling until more Na⁺ is added.

Methods for preparing solid carrageenan are well known to those of skill in the art. One of the most common of such methods is described in U.S. Pat. No. 3,094,517 read in combination with U.S. Pat. No. 3,907,770 to Strong (the disclosure of which is incorporated herein by reference), in which seaweed is extracted at high temperatures with a surplus of calcium hydroxide and then left for an extended period of time a high pH to accomplish complete alkali modification of the carrageenan polymer before precipitation. Another suitable technique is disclosed in U.S. Pat. No. 5,801,240 to Rideout et al. (the disclosure of which is incorporated herein by reference), where potassium hydroxide-treated seaweed, after treatment and washing, can be extracted at high temperature with water before precipitation. Yet another method is disclosed in U.S. Pat. No. 5,502,179 to Larsen (the disclosure of which is incorporated herein by reference), where potassium chloride is used to form the carrageenan precipitate.

According to exemplary embodiments, a carrageenan solid may be contacted with an ion exchange medium to alter the cation content of the carrageenan solid. Ion exchange is a reversible chemical reaction in which an ion in a fluid medium (such as an aqueous solution) is exchanged for a similarly charged ion attached to a polymer in a static medium.

Conventional carrageenan ion exchange is described in U.S. patent application Ser. No. 12/403,097, filed Mar. 12, 2009, entitled “Carrageenan Modified by Ion-Exchange Process” (the disclosure of which is incorporated herein by reference). In general, the process uses either an ion exchange resin or a displacement of undesirable cations with a surplus of another desirable cation, on the carrageenan extract while it is dissolved in an extraction solution.

The process for producing carrageenans according to the present invention will now be described in greater detail.

The solid carrageenan is obtained using one of the aforementioned processes or some other suitable process. In some embodiments, the solid carrageenan is a dry powder.

Embodiments of the present invention relate to processes for producing an ion-exchanged carrageenan composition. Generally described, an exemplary process comprises treating a dry carrageenan solid with an aqueous treatment solution comprising a first alcohol in an amount from about 40 vol % to about 60 vol % of the aqueous treatment solution and a salt, wherein the carrageenan solid remains substantially undissolved during the treating step; and washing the treated carrageenan solid using an aqueous washing solution comprising a second alcohol in an amount from about 40 vol % to about 60 vol % of the aqueous washing solution to obtain the ion-exchanged composition.

In another exemplary process, the dry carrageenan solid may be treated with an aqueous treatment solution comprising a first alcohol in an amount from about 40 vol % to about 60 vol % of the aqueous treatment solution and a salt, wherein the carrageenan solid remains substantially undissolved during the treating step and the treatment solution has a pH in the range of about 8 to about 10; and washing the treated carrageenan solid using an aqueous washing solution comprising a second alcohol in an amount from about 40 vol % to about 60 vol % of the washing solution, wherein the aqueous washing solution has a pH in the range of about 8 to about 10, to obtain the ion-exchanged carrageenan composition.

In yet another exemplary process, a process for producing an ion-exchanged carrageenan composition may comprise flowing an aqueous treatment solution, comprising a first alcohol in an amount from about 40 vol % to about 60 vol % of the aqueous treatment solution and a salt, through a layer of a dry carrageenan solid, wherein the carrageenan solid remains substantially undissolved during the treatment step; and flowing an aqueous washing solution, comprising a second alcohol in an amount from about 40 vol % to about 60 vol % of the aqueous washing solution, through the layer of the carrageenan solid to obtain the ion-exchanged carrageenan composition. In some embodiments, the ion exchange process step takes place very quickly, and the ion exchange step is well-suited for a continuous process such as flowing solutions through a solid plug of carrageenan. For example, the carrageenan powder may be washed with ion exchange medium, in which the flow rate of the treatment solution and the thickness of the powder layer determine, in part, the extent to which the powder may be ion exchanged.

In some embodiments, the carrageenan solid may be selected from the group consisting of iota carrageenan, kappa carrageenan, and combinations thereof. In some embodiments, the carrageenan solid may be a kappa-iota hybrid carrageenan. In still other embodiments, the carrageenan solid may be lambda carrageenan.

The carrageenan solid may be obtained from any suitable carrageenan-containing material. Carrageenan containing materials include, but are not limited to red seaweed. Carrageenan may be extracted from the carrageenan containing materials according to known or later-developed extraction techniques. For example, the carrageenan may be extracted in a completely alkali modified, or partly alkali modified process (i.e., traditionally extracted), or in a process that is not alkali modified, such as where the seaweed is extracted under neutral conditions (i.e., neutrally extracted).

In some embodiments, the first alcohol may be present in the aqueous treatment solution in an amount from about 40 vol % to about 60 vol %, from about 45 vol % to about 55 vol %, or from about 48 vol % to about 52 vol %. In other embodiments, the second alcohol may be present in the aqueous washing solution in an amount from about 40 vol % to about 60 vol %, from about 45 vol % to about 55 vol %, or from about 48 vol % to about 52 vol %.

In some embodiments, the first alcohol may be selected from the group consisting of methanol, ethanol, isopropanol, and combinations thereof. As used herein, “methanol” is synonymous with methyl alcohol and methyl hydroxide. As used herein, “ethanol” is synonymous with ethyl alcohol and ethyl hydroxide. As used herein, “isopropanol” is synonymous with isopropyl alcohol, 1-methylethanol, 2-hydroxypropane, and 2-propanol. In other embodiments, the second alcohol may be selected from the group consisting of methanol, ethanol, isopropanol, and combinations thereof. In some embodiments, the first alcohol and the second alcohol may be the same.

In embodiments of the present invention, the treatment solution further comprises a salt. In some embodiments, the salt may include but is not limited to sodium chloride (NaCl), sodium hydroxide (NaOH), sodium bicarbonate (NaHCO₃), sodium carbonate (Na₂CO₃), sodium phosphate (Na₃PO₄), sodium tripolyphosphate (Na₅P₃O₁₀), sodium hexametaphosphate ((NaPO₃)₆), sodium sulfate (Na₂SO₄), potassium chloride (KCl), potassium hydroxide (KOH), potassium carbonate (K₂CO₃), calcium chloride (CaCl₂), calcium hydroxide (Ca(OH)₂), calcium carbonate (CaCO₃), magnesium chloride (MgCl₂), magnesium hydroxide (Mg(OH)₂), magnesium carbonate (MgCO₃), and magnesium sulfate (MgSO₄). In some embodiments, one or more salts may be used. In embodiments of the present invention, the treatment solution comprising water and alcohol is saturated with the desired cationic salt or salts. Saturation is achieved by dissolving as much of the salt (or salts) as possible into the water/alcohol solution and then using only the clear liquid treatment solution, without any solid precipitate, for treating the carrageenan solid.

In some embodiments, both the treatment solution and the washing solution may have a pH in the range of about 8 to about 10, about 9 to about 10, or about 9.5 to about 10. The treatment solution and the washing solution may be prepared as basic solutions, with a desired basic pH, by adding an appropriate quantity of any suitable base. Suitable bases include, but are not limited to, ammonium hydroxide (NH₄OH), sodium hydroxide (NaOH), sodium carbonate (Na₂CO₃), potassium hydroxide (KOH), potassium carbonate (K₂CO₃), calcium hydroxide (Ca(OH)₂), calcium carbonate (CaCO₃), calcium oxide (CaO), lithium hydroxide (LiOH), and magnesium hydroxide (Mg(OH)₂).

In some embodiments, the temperature during the treating step ranges from about 0° C. to about 80° C., from about 10° C. to about 50° C., or from about 15° C. to about 40° C. In some embodiments, the duration of the treating step is in the range of about 1 minute to about 24 hours, from about 1 minute to about 8 hours, or from about 5 minutes to about 120 minutes.

In some embodiments, the temperature during the washing step ranges from about 0° C. to about 80° C., from about 10° C. to about 50° C., or from about 15° C. to about 40° C. In some embodiments, the duration of the washing step is in the range of about 1 minute to about 24 hours, from about 1 minute to about 8 hours, or from about 5 minutes to about 120 minutes.

Other aspects of the processes for production of carrageenan according to the present invention are not particularly limited, and where necessary conventional carrageenan technology may be used. In addition to the specific steps set forth herein, processes of the present invention may further comprise additional processes typically associated with carrageenan production.

### EXAMPLES

The exemplary embodiments will now be explained in greater details with respect to the following non-limiting examples. These examples and their accompanying textual descriptions will present detailed descriptions of the process of the exemplary embodiments as well as results obtained from the experimental process. Additionally, analysis of the results will be presented and supplemented by possible theoretical explanations.

Equipment:

Beakers, 1 liter and 2 liter.

2 liter conical flask, Buchner funnel and vacuum pump.

Filter cloth.

Analytical balance, weighing to two decimal places—Sartorius Basic B3 IOOP manufactured by Sartorius GmbH, Germany.

Glass filter, Duran pore-size 2, manufactured by Schott, Germany.

Chemicals:

CaCl₂, CAS no. 10043-52-4. (Merck KGaA, Darmstadt, Germany)

KCl, CAS no. 7447-40-7. (Merck KGaA, Darmstadt, Germany)

K₂CO₃, CAS no. 584-08-7. (Merck KGaA, Darmstadt, Germany)

NaCl, CAS no. 7647-14-5 (Merck KGaA, Darmstadt, Germany)

Ethanol, 96%. (Merck KGaA, Darmstadt, Germany)

Isopropyl alcohol, 100%. (Merck KGaA, Darmstadt, Germany)

Analytical measurements were performed using an ICP-AES model Vista-PRO AX (inductively coupled plasma atomic emission spectroscopy) by Varian (now Agilent Technologies, Santa Clara, Calif.).

### Example 1

### Ion Exchange of Iota Carrageenan

A first sample of iota carrageenan powder (2 g, dry powder) was treated at ambient temperature with 100 mL of a solution containing 50 vol % isopropyl alcohol in water and that was almost saturated with NaCl. The solid carrageenan was placed on a glass filter and treated with the solution with vacuum suction over the span of six hours. After this, the treated solid carrageenan (“Na-exchanged”) was washed with 100 mL of a solution containing 50 vol % isopropyl alcohol in water over the course of six hours. In both the treating and the washing steps, the applicable solution was added to the solid carrageenan powder in a continuous fashion to prevent the solid carrageenan powder from running dry.

A second sample of iota carrageenan powder (2 g, dry powder) was similarly treated at ambient temperature with 100 mL of a solution containing 50 vol % isopropyl alcohol in water and that was almost saturated with CaCl₂. The solid carrageenan was placed on a glass filter and treated with the solution with vacuum suction over the span of six hours. After this, the treated solid carrageenan (“Ca-exchanged”) was washed with 100 mL of a solution containing 50 vol % isopropyl alcohol in water over the course of six hours. In both the treating and the washing steps, the applicable solution was added to the solid carrageenan powder in a continuous fashion to prevent the solid carrageenan powder from running dry.

A third sample of iota carrageenan powder was not treated (“Control”).

The ion content of an untreated iota carrageenan, the sodium-exchanged iota carrageenan, and the calcium-exchanged iota carrageenan were measured for elemental analysis using ICP. The results are set forth in Table 1, below:

TABLE 1

| | [K⁺] | [Na⁺] | [Ca²⁺] | [Mg²⁺] |
|---|---|---|---|---|
| Sample | (mg/g) | (mg/g) | (mg/g) | (mg/g) |
| Control | 53 | 17.2 | 29.6 | 1.2 |
| Ca-exchanged | 4.2 | 0.02 | 52.7 | 0.32 |
| Na-exchanged | 2.9 | 61.8 | 0.34 | 0.34 |

As demonstrated by the data presented in Table 1, treating an iota carrageenan solid with a solution comprising a sodium cation resulted in an increase of the sodium ion concentration to 61.8 mg/g and decreases in the potassium, calcium, and magnesium ion concentrations. Similarly, treating an iota carrageenan solid with a solution comprising a calcium cation resulted in an increase of the calcium ion concentration to 52.7 mg/g and decreases in the potassium, sodium, and magnesium cation concentrations.

### Example 2

### Ion Exchange of Kappa-Iota Hybrid Carrageenan

In this example, a traditional kappa-iota hybrid carrageenan powder was first extracted with calcium hydroxide. A 7% KCl treatment solution was prepared by dissolving 2.240 kg of KCl in 12 liters of deionized water and then diluting with 20 liters of 80% isopropyl alcohol. Carrageenan powder (1 kg, dry powder) was dispersed in 5 liters of the treatment solution at ambient temperature and then was placed onto a filter unit containing a filter cloth. After the treatment solution drained from the carrageenan powder, an additional 9 liters of the treatment solution was added so as to flow through the layer of wetted carrageenan powder without stirring. The entire treatment process was carried out at ambient temperature over the course of two hours. After treatment, the carrageenan powder layer was washed with 5 liters of a 50% isopropyl alcohol in water washing solution (without added salt) to remove excess salts. The entire washing process was carried out at ambient temperature over the course of two hours. The process of adding 9 liters of the treatment solution was repeated and samples were taken for elemental analysis after each successive treatment.

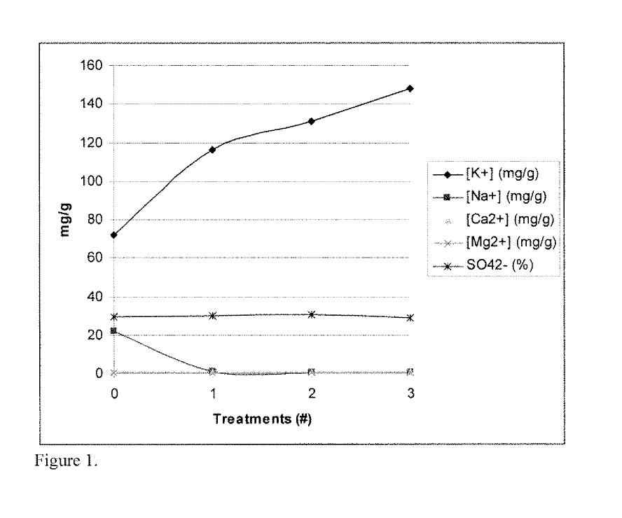

The ion content was measured for the non-ion-exchanged control sample (identified as 0) and each ion-exchanged sample. The results are set forth in Table 2, below, as well as in FIG. 1.

TABLE 2

| # of | [K⁺] | [Na⁺] | [Ca²⁺] | [Mg²⁺] | S0₄²⁻ |
|---|---|---|---|---|---|
| treatments | (mg/g) | (mg/g) | (mg/g) | (mg/g) | (%) |
| 0 | 71.96 | 21.9 | 1.05 | 0.42 | 29.4 |
| 1 | 116.03 | 1.23 | 0.81 | 0.32 | 30.3 |
| 2 | 130.91 | 0.56 | 0.83 | 0.37 | 30.7 |
| 3 | 148.16 | 0.39 | 0.83 | 0.32 | 29 |

As demonstrated by the data presented in Table 2, successive treatments of the kappa-iota hybrid carrageenan solid with a treatment solution comprising potassium cations resulted in increasing potassium cation concentrations in the corresponding products. It can also be noted that the level of backbone sulfate (SO₄²⁻) remained nearly constant over the course of treatment, suggesting little degradation of the carrageenan polymer backbone with multiple treatment steps.

It should be apparent that the foregoing relates only to the preferred embodiments of the present invention and that numerous changes and modifications may be made herein without departing from the spirit and the scope of the invention as defined by the following claims and equivalents thereof

We claim:

1. A process for producing an ion-exchanged carrageenan composition, comprising the steps of:
treating a carrageenan solid with an aqueous treatment solution comprising a first alcohol in an amount from about 40 vol % to about 60 vol % of the aqueous treatment solution and a salt, wherein the carrageenan solid remains substantially undissolved during the treating step; and
washing the treated carrageenan solid using an aqueous washing solution comprising a second alcohol in an amount from about 40 vol % to about 60 vol % of the aqueous washing solution to obtain the ion-exchanged carrageenan composition.

2. The process of claim 1, wherein the first alcohol is present in the aqueous treatment solution in an amount from about 48 vol % to about 52 vol %.

3. The process of claim 1, wherein the second alcohol is present in the aqueous washing solution in an amount from about 48 vol % to about 52 vol %.

4. The process of claim 1, wherein the first alcohol is selected from the group consisting of methanol, ethanol, isopropanol, and combinations thereof.

5. The process of claim 1, wherein the second alcohol is selected from the group consisting of methanol, ethanol, isopropanol, and combinations thereof.

6. The process of claim 1, wherein the carrageenan solid is selected from the group consisting of iota carrageenan, kappa carrageenan, and combinations thereof.

7. The process of claim 1, wherein the treating step and the washing step are both performed at a temperature in the range of about 0° C. to about 80° C.

8. A process for producing an ion-exchanged carrageenan composition, comprising the steps of:
treating a carrageenan solid with an aqueous treatment solution comprising a first alcohol in an amount from about 40 vol % to about 60 vol % of the aqueous treatment solution and a salt, wherein the carrageenan solid remains substantially undissolved during the treating step and the treatment solution has a pH in the range of about 8 to about 10; and
washing the treated carrageenan solid using an aqueous washing solution comprising a second alcohol in an amount from about 40 vol % to about 60 vol % of the aqueous washing solution, wherein the aqueous washing solution has a pH in the range of about 8 to about 10, to obtain the ion-exchanged carrageenan composition.

9. The process of claim 8, wherein the first alcohol is present in the aqueous treatment solution in an amount from about 48 vol % to about 52 vol %.

10. The process of claim 8, wherein the second alcohol is present in the aqueous washing solution in an amount from about 48 vol % to about 52 vol %.

11. The process of claim 8, wherein the first alcohol is selected from the group consisting of methanol, ethanol, isopropanol, and combinations thereof.

12. The process of claim 8, wherein the second alcohol is selected from the group consisting of methanol, ethanol, isopropanol, and combinations thereof.

13. The process of claim 8, wherein the carrageenan solid is selected from the group consisting of iota carrageenan, kappa carrageenan, and combinations thereof.

14. The process of claim 8, wherein the treating step and the washing step are both performed at a temperature in the range of about 0° C. to about 80° C.

15. A process for producing an ion-exchanged carrageenan composition, comprising:
flowing an aqueous treatment solution, comprising a first alcohol in an amount from about 40 vol % to about 60 vol % of the aqueous treatment solution and a salt, through a layer of a carrageenan solid, wherein the carrageenan solid remains substantially undissolved; and
flowing an aqueous washing solution, comprising a second alcohol in an amount from about 40 vol % to about 60 vol % of the aqueous washing solution, through the layer of the carrageenan solid to obtain the ion-exchanged carrageenan composition.

16. The process of claim 15, wherein the first alcohol is present in the aqueous treatment solution in an amount from about 48 vol % to about 52 vol %.

17. The process of claim 15, wherein the second alcohol is present in the aqueous washing solution in an amount from about 48 vol % to about 52 vol %.

18. The process of claim 15, wherein the first alcohol is selected from the group consisting of methanol, ethanol, isopropanol, and combinations thereof.

19. The process of claim 15, wherein the second alcohol is selected from the group consisting of methanol, ethanol, isopropanol, and combinations thereof.

20. The process of claim 15, wherein the carrageenan solid is selected from the group consisting of iota carrageenan, kappa carrageenan, and combinations thereof.
